(19) United States
(12) Patent Application Publication
(10) Pub. No.: US 2012/0054017 A1
(43) Pub. Date: Mar. 1, 2012

(54) Renewable energy consumption management using renewable energy consumption coupons

(76) Inventor: Bindu Rama Rao, Laguna Niguel, CA (US)

(21) Appl. No.: 12/807,168

(22) Filed: Aug. 30, 2010

(51) Int. Cl. G06Q 30/00; G06Q 90/00

(52) U.S. Cl. 705/14.39; 705/500; 705/14.1

(57) ABSTRACT

A distribution system ensuring that the amount of renewable energy coupons distributed is correlated to and commensurate with the aggregate amount of renewable energy generated by the plurality of renewable energy generators. In general, the present invention makes it possible to securely authenticate a user and then permit renewable energy coupon purchases over the user's laptop or mobile phone. It makes it possible for power generation data to be aggregated across several renewable energy power generating companies (and their systems) and collectively provide renewable energy coupons to all their customers, wherein the amount of coupons issued are in correlation to the actual amount of electricity generated across all of the renewable energy power generating companies.

### CROSS REFERENCES TO RELATED APPLICATIONS

### BACKGROUND

1. Technical Field

The present invention relates generally to management of consumption of renewable energy, and specifically to the use of renewable energy consumption coupons that guarantees that energy consumed by a user is generated from renewable resources.

2. Related Art

In the last decade, several companies have started environmentally friendly electricity generation services. Renewable energy nowadays may come from landfill gas, hydro, biomass (certain types of wood burning facilities), solar and wind energy sources. Some consumers would prefer to sign up energy companies that generate 100% of their electricity from renewable sources. Often, there is no easy way for a consumer to determine where the energy he consumes comes from, what resource electricity is generated from, etc. In addition, consumers do not even know, and have no easy way to determine, if the electricity supplied to them from the grid comes from renewable energy sources or from burning coal or oil.

Even if consumers want to become “green”, and reduce their carbon footprint, it is often the case that they end up increasing their carbon footprint. For example, when a user who has purchased an electric car plugs it into an electric socket at home to recharge the batteries, the utility company providing electricity through the grid to the consumer may be generating electricity using coal burning power stations or oil burning power stations, etc. There is no way a consumer can guarantee that the electricity/power that he consumes from the power grid, such as for the electricity used to charge the batteries of the consumer's electric car, comes only from renewable energy resources.

There are a lot of retail electric providers in a number of states in the United States that are capable of generating electricity and delivering them to the power grid. Some these (rather a few of these) generate power from renewable resources. Often such power is combined with power generated from nuclear power stations, oil fired generator plants, geo-thermal plants, solar power generating farms, wind powered power companies, etc. when it is delivered over the grid to consumers.

There are currently no generally available means by which a consumer, while taking power from the grid, can ensure that his power is generated only from renewable energy sources, if he so desires. Even if he wanted to ensure that his power needs were mostly/primarily met by power generated from renewable sources, there is no solution that is generally and commercially available that helps a consumer ensure that. There are no easy means by which a producer of power from renewable resources can provide his customers an opportunity to verify that the power they consume has been contributed by power generated from renewable resources. There are no means available by which manufacturers of green appliances and vehicles can guarantee that the power such appliances and vehicles consume will be met by power generated from renewable resources.

There are no easy means by which a person can determine where the electricity used by him at his house comes from, or from what type of resources it is generated from, or where it comes from. Short of generating power himself using his own personal power generating systems, there are no ways by which a typical user of any power utility can determine if the energy that his home appliances consume daily are generated from renewable resources.

In view of the foregoing considerations, it is clear that there is a need for an improved system and method that is capable of guaranteeing that energy consumed is generated from renewable resources. There is a need for a system wherein a user can request, purchase and seek allocation of power/electricity that has been generated using only renewable resources.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a perspective block diagram of a distribution system 105 for renewable energy coupons that makes it possible for users to purchase renewable energy and acquire renewable energy coupons for the energy that their appliances and vehicles consume.

FIG. 2 is a perspective block diagram of a renewable energy consumption management system comprising an aggregation module to aggregate data provided by a plurality of renewable energy generators to produce an aggregated renewable energy amount, and a coupon generation module for generating and distributing renewable energy consumption coupons wherein the total amount of renewable energy consumption coupons are correlated to the aggregated renewable energy amount.

FIG. 3 is a flow chart of an exemplary operation of the renewable energy consumption management system, as it implements a method of renewable energy consumption management.

FIG. 4 is another flow chart of a different exemplary operation of the renewable energy consumption management and distribution system.

FIG. 5 is a block diagram describing the exemplary components of an exemplary renewable energy coupon.

### DETAILED DESCRIPTION OF THE DRAWINGS

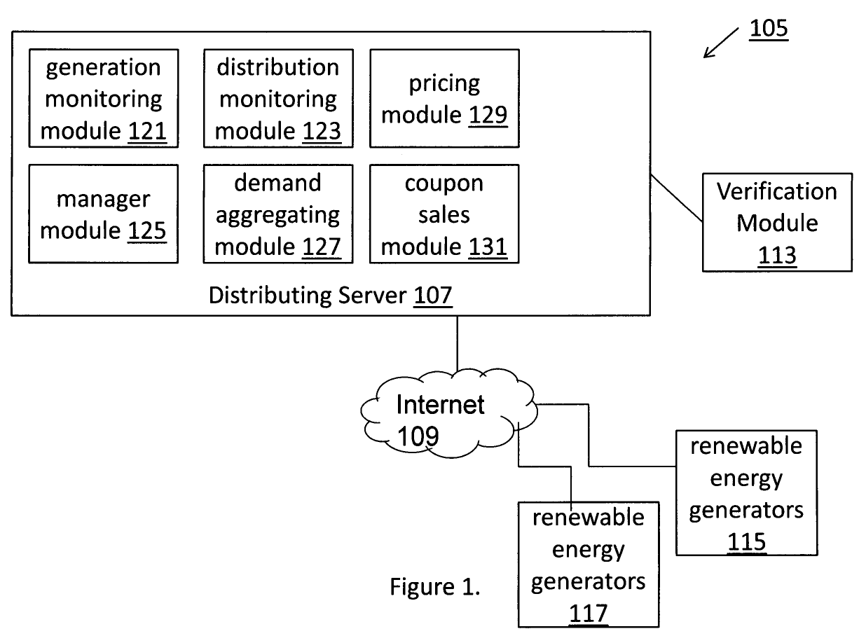

FIG. 1 is a perspective block diagram of a distribution system 105 for renewable energy coupons that makes it possible for users to purchase renewable energy and acquire renewable energy coupons for the energy that their appliances and vehicles consume. These renewable energy coupons are provided by renewable energy generating companies so that users can get renewable energy coupons and use them to pay for the energy that their appliances and vehicles consume, thereby ensuring that such appliances and vehicles have smaller carbon footprint and consume power/electricity that is guaranteed to come from green/renewable resources.

The distribution system 105 for renewable energy coupons comprises a distributing server (with web-presence) 107 accessible on the Internet 109 for providing buyers and sellers of renewable energy coupons a mechanism for requesting and dispensing coupons. It also comprises a verification module 113 for automatically verifying that the generation of a unit of renewable energy conforms to a particular generation standard. The verification module 113 is responsible for attaching such verification to each coupon dispensed by the distributing server 107.

The distribution system 105 for renewable energy coupons also provides a mechanism for aggregating fractional units of renewable energy generated by a plurality of renewable energy generators 115, 117 into lots suitable for allotment to a plurality of users/consumers, wherein renewable energy coupons purchased by such users/consumers serves as one means to pay for energy consumed by users/consumers. The distribution system 105 facilitates selling renewable energy coupons on the distributing server 107 wherein the amount of renewable energy coupons dispensed is commensurate with the amount of renewable energy generated. Thus, only the appropriate amount of coupons are created and sold (or made available for sale) based on an aggregate amount of renewable energy currently being generated/aggregated from a plurality of sources.

The distributing server 107 comprises a generation monitoring module 121 that keeps track of the actual amount of renewable energy generated by a plurality of renewable energy generators 115, 117, and a distribution monitoring module 123 that keeps track of the volume of renewable energy coupons distributed. It also comprises a manager module 125 that ensures that the volume of renewable energy coupons distributed is correlated to and commensurate with the actual amount of renewable energy generated.

The distributing server 107 further comprises a demand aggregating module 127 that collates and computes the overall demand for renewable energy coupons and a pricing module 129 that computes a current price for each unit of renewable energy based on data provided by the demand aggregating module. It also comprises a coupon sales module 131 that facilitates purchase of coupons, and the purchase of bulk energy (such as by a customer operating a manufacturing plant).

The distribution system 105 facilitates the purchasing of renewable energy consumption coupons on a website associated with the distribution system 105. It can also facilitate download of renewable energy consumption coupons by a user, or send it via email to one or more users. It can also securely store the coupons online (in a special user wallet) for the user until the user is ready to redeem those coupons. The user can optionally (in some embodiments) register the renewable energy consumption coupons with the distribution system 105 prior to redeeming those coupons.

An individual user can also purchase renewable energy consumption coupons on the website associated with the distribution system 105. For example, a user can purchase 12 coupons, one for each month of a year, and have them delivered to his email address (or residential address in the form of physical coupons).

In general, the present invention provides the means by which a consumer, while taking power from the grid, can ensure that his power is generated only from renewable energy sources, if he so desires. Even if a consumer (such as one who purchased an electric car) wanted to ensure that his power needs were mostly/primarily met by power generated from renewable sources, the present invention makes it possible to provide the consumer with renewable energy consumption coupons thereby ensuring that an equivalent amount of energy is pumped into the grid, that is generated from renewable resources. The present invention also provides the means by which a producer of power from renewable resources can provide his customers an opportunity to verify that the power they consume has been contributed by power generated from renewable resources. Similarly manufacturers of green appliances and vehicles can now, by distributing renewable energy coupons to their customers, guarantee that the power such appliances and vehicles consume will be met by power generated from renewable resources. Manufacturers of electric vehicles can provide a multi-year supply of renewable energy coupons to their customers, enabling such customers to avail of electricity for recharging their electric vehicles and pay for the energy using the coupons provided by the manufacturers.

A manufacturer of an electric vehicles can now acquire the renewable energy coupons from the distribution system 105, in bulk if necessary, and give those coupons to the buyers of their vehicles, so as to promote use of green technology wherein all the energy needs of the electric vehicles are met by power produced by other green technologies, namely power generated from renewable resources from renewable energy generation plants, etc.

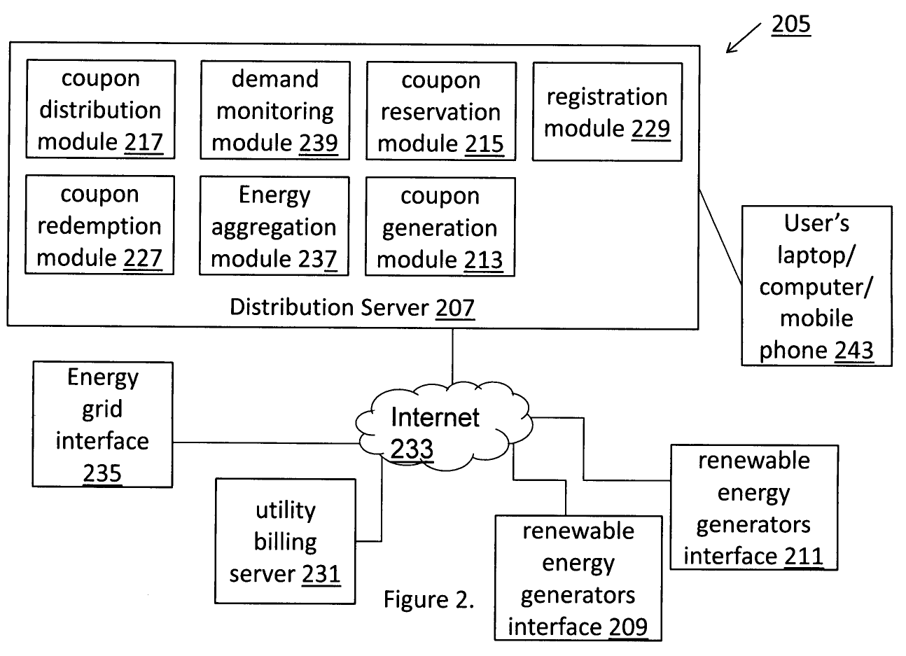

FIG. 2 is a perspective block diagram of a renewable energy consumption management and distribution system 205 comprising an aggregation module 207 to aggregate data provided by a plurality of renewable energy generators 209, 211 to produce an aggregated renewable energy amount, and a coupon generation module 213 for generating and distributing renewable energy consumption coupons wherein the total amount of renewable energy consumption coupons are correlated to the aggregated renewable energy amount. The renewable energy consumption management system 205 also comprises a coupon reservation module 215 and a coupon distribution module 217. The coupon reservation module 215 facilitates the allocation of a subset of the renewable energy consumption coupons to an individual promotion company that promotes distribution of the subset of the renewable energy consumption coupons to a target group of users. The coupon distribution module 217 facilitates the distribution of the subset of the renewable energy consumption coupons to the target group of users.

The renewable energy consumption management and distribution system 205 further comprises a distribution server 207 for receiving reports of renewable energy generation from a plurality of renewable energy generator systems 209, 211, and for aggregating generation and dissemination of renewable energy coupons. The distribution server 207 hosts the coupon generation module 213 and the coupon reservation module 215. It also comprises a coupon redemption module 227 that facilitates redemption of the subset of the renewable energy consumption coupons by the target group of users and a registration module 229 that is used by the target group of users to register the distributed ones of the subset of the renewable energy consumption coupons prior to consumption of renewable energy.

The distribution server 207 manages a demand monitoring module 239 that keeps track of demand for renewable energy consumption coupons by corporate customers, different sales channels and by consumers. It also manages an energy aggregation module 237 that monitors renewable energy generation data provided by the renewable energy generators, via renewable energy generator interfaces 209, 211 and aggregates energy generated by different types of energy generation plants, such aggregation occurring by resources types, energy generation technology types, and across those types.

The coupon redemption module 227 facilitates periodic bill payment by each of the target group of users, incorporating the corresponding ones of renewable energy consumption coupons provided to each of the target group of users. In one embodiment, the renewable energy consumption coupons, prior to redemption, are optionally securely stored at the distribution server 207 for subsequent retrieval and redemption.

In one embodiment, the renewable energy consumption management and distribution system 205 also comprises a coupon sales module that facilitates sale of renewable energy consumption coupons to a plurality of consumers, wherein each of the plurality of consumers purchase at least one of the renewable energy consumption coupons and subsequently redeem the at least one of the renewable energy consumption coupons during a subsequent bill payment activity with a local utility company, the coupon sales module also facilitating the bill payment activity by means of validation support and settlement support. Validation support includes validating a coupon prior to its being factored into a bill payment activity. Settlement support includes funds transfer between bank accounts (or credit card accounts, etc.) to pay the face value of a renewable energy consumption coupon presented for “settlement” by a utility company or some entity to which a user has submitted the renewable energy consumption coupon as part of full payment or partial payment of an energy consumption bill.

Typically, a local utility company (or local electric company) services a number of consumers in a region, and accepts the renewable energy consumption coupons submitted by the user as full or partial payment during a bill payment activity, which can be conducted online via an online bill payment service offered by the local utility company. The renewable energy consumption coupons can be used by a user for bill payment online or in offline mode (i.e. bill payment via a check or cash, with the “face value” of one or more renewable energy consumption coupons submitted by the user being factored in).

The renewable energy consumption management and distribution system 205 identifies/certifies those of the target group of users who successfully employ the associated renewable energy consumption coupons, to pay for the entire energy consumed by a purchased appliance or vehicle as green consumers (GC). In general it is capable of determining which of the target group of users are able to successfully meet all their energy needs employing the renewable energy coupons (for users who cannot meet all their energy needs from renewable energy coupons, the system 205 encourages them to acquire additional coupons, and facilitates such acquisitions). It also facilitates coupon settlement by an utility billing server 231 associated with a utility company that accepts the renewable energy coupons redeemed by the target group of users as partial or complete payments for energy consumed from a energy grid that is maintained and managed by a corresponding utility company. Interactions with and monitoring of the energy grid are possible via the energy grid interface 235.

In one embodiment, renewable energy consumption management and distribution system 205 facilitates purchasing of renewable energy consumption coupons by a user from a website associated with the renewable energy consumption management and distribution system 205. The user then receives the purchased renewable energy consumption coupons via email or as a download. The user can store the received purchased renewable energy consumption securely until it is used. The user can also register the supply of renewable energy consumption coupons with the renewable energy consumption management and distribution system 205 prior to using the coupon, in one related embodiment.

In one embodiment, renewable energy consumption management and distribution system 205 also comprises a utility billing server interface that provides access to data maintained by a utility company, wherein the utility company maintains and manages an energy grid. The utility billing server interface provides access to a utility company billing server associated with the utility company. The renewable energy consumption management and distribution system 205 conducts renewable energy coupon settlement with the utility company billing server, via the utility billing server interface. For example, when the utility company billing server accepts the renewable energy coupons redeemed by the target group of users as partial or complete payments for energy consumed by them, it communicates the accepted renewable energy coupons for verification to the renewable energy consumption management and distribution system 205, which in turn validates the coupons, and confirms their authenticity (authentication can be performed in one or more ways, such as verifying that the coupon identification and associated user information are accurate, etc.), and conducts coupon settlement activities.

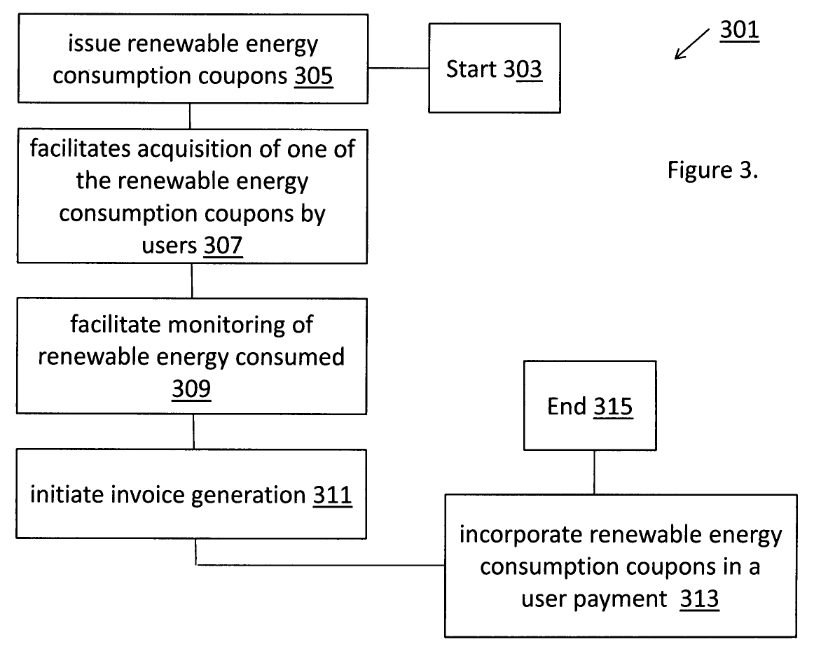

FIG. 3 is a flow chart of an exemplary operation of the renewable energy consumption management system 205, as it implements a method 301 of renewable energy consumption management. Processing starts at the start block 303 when the management system 205 receives details of renewable energy generated from one or more renewable energy plants/installations. Specifically, it determines the amount of renewable energy currently being produced by one or more renewable energy plants/installations.

At a next block 305, the management system 205 issues renewable energy consumption coupons, on behalf of a renewable energy generator company, for renewable energy consumption by a plurality of users. The quantity of renewable energy consumption coupons is correlated to the amount of renewable energy produced by the renewable energy generator company. Then, at a next step 307, renewable energy consumption management system 205 facilitates acquisition of one of the renewable energy consumption coupons by one of the plurality of users. For example, the user might get his coupons mailed to him as an attachment to an email from a appliance vendor or a vehicle manufacturer. In addition, the user can go online using a laptop, PC or mobile phone and purchase coupons for renewable energy from web-pages provided by the renewable energy consumption management system 205. At a next step 309, it facilitates monitoring of renewable energy consumed by each of the one of the plurality of users. For example, such monitoring occurs actively in one embodiment employing an energy monitor attached to the appliance at home or to a charging vehicle in the garage of the user at home, wherein the energy monitor reports (periodically or when triggered remotely) actual energy consumed by the appliance or vehicle in a billing period (associated with a billing cycle, for example).

Then, at a next block 311, it initiates invoice generation, and the factoring of the one of the renewable energy consumption coupons into an invoice generated for the one of the plurality of users. Later, at a next block 313, it initiates incorporating the one of the renewable energy consumption coupons in a payment made by the one of the plurality of users against the invoice.

Processing terminates at the next end block 315.

In one embodiment, monitoring of renewable energy consumption by the user at the step 309 includes automatically reporting consumption data to centralized servers that track the consumption of fractional units of renewable energy by the one of the plurality of users. It also involves accumulating fractional units of qualifying renewable energy consumed by the one of the plurality of users.

In general, in this method, coupons are denominated in kilowatt-hours of energy for renewable energy produced from a plurality of renewable energy generators.

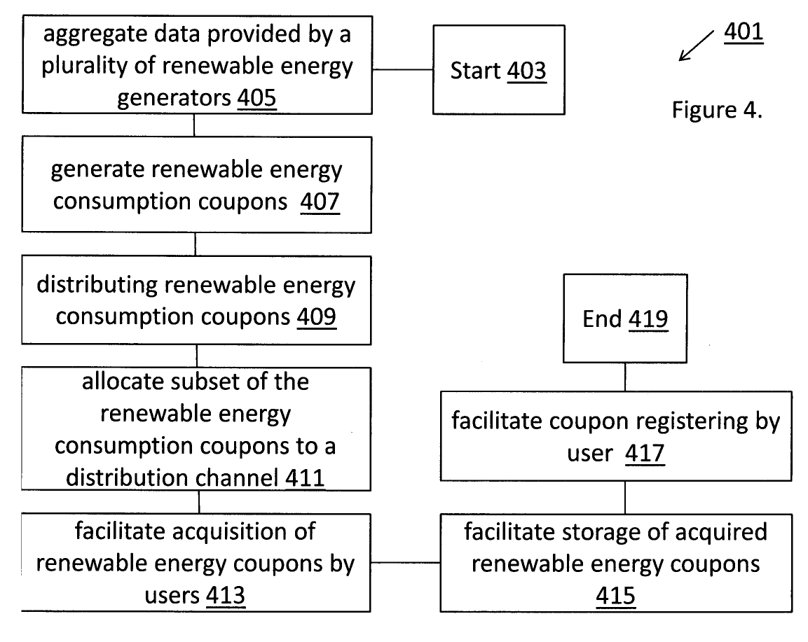

FIG. 4 is another flow chart of a different exemplary operation of the renewable energy consumption management and distribution system 205. Processing starts at a start block 403 when the renewable energy consumption management and distribution system 205 determines the amount of energy being generated from renewable resources by one or more renewable energy generators. Then at a next block 405, the system 205 begins aggregating data provided by a plurality of renewable energy generators to produce an aggregated renewable energy amount. Then at a next block 407, it starts generating renewable energy consumption coupons. Then at a next block 409, it starts distributing renewable energy consumption coupons wherein the total amount of renewable energy consumption coupons are correlated to the aggregated renewable energy amount. Then, at a next block 411, it also begins allocating a subset of the renewable energy consumption coupons to an individual distribution channel. For example, in one embodiment, the individual distribution channel is a company that promotes distribution of the subset of the renewable energy consumption coupons to a target group of users.

Later, at a next block 413, acquisition of renewable energy coupons by users is facilitated. In one embodiment, acquisition comprises receiving a supply of renewable energy consumption coupons from a manufacturer when a user purchases an energy consuming appliance or vehicle. Acquisition also comprises the user going to the sales website provided by the system 205 and purchasing renewable energy consumption coupons for a specific period (wherein the period can be one month or a series of months in a year). At a next block 415, the storage of the acquired renewable energy coupons by the user is facilitated. In one related embodiment, the user stores them locally in his PC/laptop/mobile phone, and in another related embodiment, the user stores them at the web server associated with the system 205 (until subsequent registration or coupon redemption, etc.).

Then, at a next block 417, the system 205 facilitates registering, by the user, the acquired supply of renewable energy consumption coupons. Registration of coupons makes it possible to easily and conveniently redeem them subsequently, as and when needed. Registration, in one embodiment, comprises accessing the sales website of the system 205 and providing a list of coupons (or a coupon identification range), optionally providing a user profile (or selecting a predefined user profile) and having the coupons validated. Then processing stops at an end block 419.

In one embodiment, the system 205 employs a sales module to facilitate the purchase of renewable energy coupons by a manufacturer customer on behalf of a plurality of the manufacturer's customers. The system 205 subsequently facilitates the distribution of those renewable energy coupons to the plurality of the manufacturer's customers.

In one embodiment, the user can specify what type of renewable energy consumption coupons he desires, such as coupons associated with solar energy or coupons associated with geo-thermal energy. Thus, a user can promote the use of, and consume energy produced by, a specific renewable technology. Alternately, the user can specify that the renewable energy consumption coupons he desires needs to be generated/produced from a specific type of renewable resource. For example, during registration, the user can optionally specify what type of renewable energy he would like to promote, and pick a primary form of renewable energy resource and a secondary form of renewable energy resource.

Registration provides the ability to uniquely identity the participant in coupon redemption, making it easy to transfer payment (and other related transactions). The user profiles are provided with a unique identification that can be retrieved and updated by the user. The user profile also helps store transaction related parameters or transaction related data (such as receipts, transaction records, etc.). It also comprises an optional set of security credentials that are used for secure communications with the user's laptop, computer or mobile phone (that is currently associated with the user) in one embodiment. In another embodiment, wherein the client certificates are used for secure mutual authenticated communications with a system 205 and the user's laptop or mobile device, the user profile/user account is used to conduct debit and credit operations during user initiated funds transfer and payments activities for renewable energy coupons, etc.

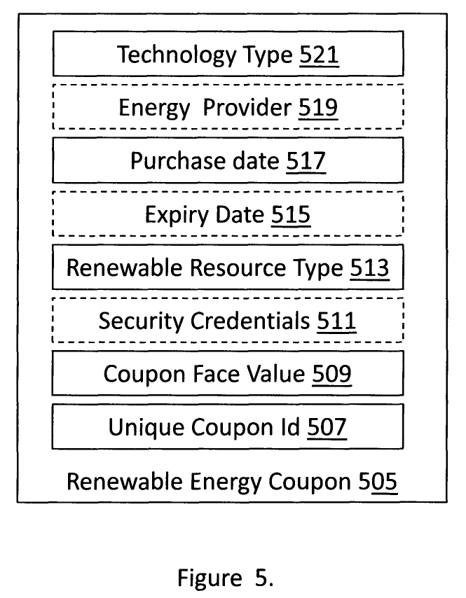

FIG. 5 is a block diagram describing the exemplary components of an exemplary renewable energy coupon 505. The renewable energy coupon 505 comprises information such as an unique coupon identification 507, a coupon face value 509, a security credentials 511, a renewable resource type 513 information, an expiry date 515, a purchase date 517, a renewable energy provider information 519 and a technology type 521. For example, one such renewable energy coupon 505 would have “112233445566” as a unique identification, a “$100” as a face value, a pincode value of “A12567” as a security credentials (PKI are also contemplated), “geothermal” as the renewable resource type, “Dec. 30, 2011” as the expiry date, “Dec. 30, 2010” as the purchase date, “Acme Rewnewable Energy Corp.” as the energy provider, and “Vertical Closed Loop” as the technology type associated.

In some embodiments, the renewable energy coupon 505 would also optionally have information on a distributor or promoter, such as a manufacturer of an electrical appliance or an electric vehicle who might have distributed the renewable energy coupon 505. It would also provide a link to information stored at website on the Internet that would explain the procedure to acquire additional coupons and the means to apply/redeem those coupons as and when needed.

In one embodiment, the renewable energy coupon 505 is a digital coupon that can be downloaded, emailed, stored in e-wallets, downloaded onto to mobile phones, stored on a database on a server, etc. They can also be printed on paper. Other forms of coupons are also contemplated, such as a 2-D barcode based coupon, a digital 2-D barcode coupon that can be viewed on mobile phones and laptops, etc. In one embodiment, the coupons are printed on paper and physically mailed to the users as part of the renewable energy consumption coupons distribution process.

In general, the present invention makes it possible to securely authenticate a user and then permit renewable energy coupon purchases over the user's laptop or mobile phone. It makes it possible for power generation data to be aggregated across several renewable energy power generating companies (and their systems) and collectively provide coupons to all their customers, wherein the amount of coupons issued are in correlation to the actual amount of electricity generated across all of the renewable energy power generating companies. The supply of coupons is thus controlled and never more than the power generated from renewable resources. Alternatively, if the demand for coupons is seen to exceed the supply of power from renewable sources, the supply can be increased/adjusted accordingly. Thus, the system 205 is capable of monitoring demand and determining if supply needs to increase or decrease based on anticipated or projected demand.

The renewable energy consumption management and distribution system 205, in one embodiment, is communicatively coupled to a power grid to which the renewable energy generators are also electrically coupled (i.e. plugged into) to deliver power generated. The renewable energy generators also communicate their power generation details to the system 205 to facilitate aggregation of power generation data across one or more renewable energy generators.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

As one of ordinary skill in the art will appreciate, the terms “energy” and “power,” “electricity”, as may be used herein, include power provided to the electric grid by various types of generating stations/plants, such power also being delivered to houses and industries for consumption. The terms “renewable energy” includes power generated from biomass, solar photo-voltaic panels, geothermal plants, hydro-electric darns, wind-powered generation units, wave-powered generation units, etc.

Although the present invention has been described in terms power generation plants generating renewable energy, it must be clear that the present invention also applies to other types of energy storage and distribution means.

In general, the terms “renewable energy coupon” and “renewable energy consumption coupon” are equivalent as used in this invention.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A method for renewable energy consumption management, the method comprising:
issuing renewable energy consumption coupons, by a renewable energy generator company, for renewable energy consumption by a plurality of users, wherein the quantity of renewable energy consumption coupons is correlated to the amount of renewable energy produced by the renewable energy generator company;
acquiring of one of the renewable energy consumption coupons by one of the plurality of users;
monitoring of renewable energy consumed by the one of the plurality of users;
generating an energy consumption invoice for the one of the plurality of users factoring in the one of the renewable energy consumption coupons; and
incorporating the one of the renewable energy consumption coupons in a payment made by the of the plurality of users against the energy consumption invoice.

2. The method of claim 1 wherein monitoring of renewable energy consumption comprises:
reporting, automatically, an energy consumption data to centralized servers that track the consumption of fractional units of a qualifying renewable energy by the one of the plurality of users; and
accumulating data on fractional units of the qualifying renewable energy consumed by the one of the plurality of users.

3. The method of claim 1 wherein the renewable energy consumption coupons are denominated in kilowatt-hours of energy for renewable energy produced from a plurality of renewable energy generator systems.

4. The method of claim 1 further comprising:
aggregating data provided by a plurality of renewable energy generators to produce an aggregated renewable energy amount;
generating renewable energy consumption coupons for the plurality of renewable energy generators, wherein the total amount of renewable energy consumption coupons are correlated to the aggregated renewable energy amount; and
allocating a subset of the renewable energy consumption coupons to an individual distribution channel that promotes distribution of the subset of the renewable energy consumption coupons to a target group of users

5. The method of claim 4 wherein the individual distribution channel is a company that manufactures at least one of electrical appliances and electric vehicles.

6. The method of claim 5 wherein aggregating comprises:
determining energy production capacity of each of plurality of renewable energy generators;
getting periodic energy production reports from each of plurality of renewable energy generators; and
computing the aggregated renewable energy amount;

7. The method of claim 1 wherein acquiring comprises:
purchasing an energy consuming appliance or vehicle and receiving a supply of renewable energy consumption coupons; and
registering the supply of renewable energy consumption coupons received.

8. The method of claim 1 wherein acquiring comprises:
purchasing renewable energy consumption coupons on a website;
receiving the purchased renewable energy consumption coupons via email or as a download;
storing, optionally, the purchased renewable energy consumption coupons securely at a server for subsequent retrieval and redemption; and
registering optionally the purchased renewable energy consumption coupons.

9. A distribution system associated with renewable energy, the distribution system comprising:
renewable energy coupons that can be bought by users;
a distributing server and web-presence, accessible on the Internet, for providing buyers and sellers of renewable energy coupons a mechanism for requesting and dispensing renewable energy coupons;
a verification module for automatically verifying that the generation of a unit of renewable energy conforms to a generation standard, and for attaching a verification information to each of the renewable energy coupons that is dispensed on the distributing server;
a management module for aggregating fractional units of renewable energy generated by a plurality of renewable energy generators into lots suitable for allotment to users by means of the renewable energy coupons;
a sales module for selling renewable energy coupons on the distribution server wherein the amount of renewable energy coupons dispensed is commensurate with the amount of renewable energy generated in aggregate by the plurality of renewable energy generators; and
the distribution system ensuring that the amount of renewable energy coupons distributed is correlated to and commensurate with the aggregate amount of renewable energy generated by the plurality of renewable energy generators.

10. The distribution system of claim 9 wherein the distribution system further comprises:
a generation monitoring module that keeps track of the actual amount of renewable energy generated by a plurality of renewable energy generators;
a distribution monitoring module that keeps track of the volume of renewable energy coupons distributed; and
a redemption monitoring module that ensures that the volume of renewable energy coupons distributed is correlated to and commensurate with the actual amount of renewable energy generated.

11. The distribution system of claim 9 wherein the distribution system further comprising;
a demand aggregating module that collates and computes the overall demand for renewable energy coupons;
a pricing module that computes a current price for each unit of renewable energy based on data provided by the demand aggregating module; and
a customer reservation module that facilitates reserving a portion of the renewable energy coupons for specific customers who want to distribute them to their users based on a customized program.

12. The distribution system of claim 9 wherein the sales module facilitates purchase of renewable energy coupons by a manufacturer customer on behalf of a plurality of the manufacturer's customers, and the subsequent distribution of those renewable energy coupons to the plurality of the manufacturer's customers.

13. A renewable energy consumption management and distribution system comprising:
an aggregation module to aggregate data provided by a plurality of renewable energy generators to produce an aggregated renewable energy amount;
a coupon generation module for generating and distributing renewable energy consumption coupons wherein the total amount of renewable energy consumption coupons are correlated to the aggregated renewable energy amount;
a coupon reservation module that facilitates the allocation of a subset of the renewable energy consumption coupons to an individual promotion company that promotes distribution of the subset of the renewable energy consumption coupons to a target group of users; and
a coupon distribution module that facilitates the distribution of the subset of the renewable energy consumption coupons to the target group of users.

14. The system of claim 13, further comprising:
a centralized server for receiving reports of renewable energy generation from a plurality of renewable energy generator systems, for aggregating renewable energy generation data received from the plurality of renewable energy generator systems and for the dissemination of renewable energy consumption coupons; and
the centralized server hosting the coupon generation module and the coupon reservation module.

15. The system of claim 13, further comprising:
a coupon sales module that facilitates sale of renewable energy consumption coupons to a plurality of consumers, wherein each of the plurality of consumers purchase at least one of the renewable energy consumption coupons and subsequently redeems the at least one of the renewable energy consumption coupons during a subsequent bill payment activity with a local utility company, the coupon sales module also facilitating the bill payment activity by means of validation support and settlement support.

16. The system of claim 13, further comprising:
a coupon redemption module that facilitates redemption of the subset of the renewable energy consumption coupons by the target group of users.

17. The system of claim 16 further comprising:
a registration module that is used by the target group of users to register the distributed ones of the subset of the renewable energy consumption coupons prior to consumption of renewable energy;
the registration module facilitating the optional specification of a preferred primary and secondary form of renewable energy generation technology from the target group of users; and
the coupon redemption module facilitating the periodic bill payment, by each of the target group of users, incorporating the corresponding ones of renewable energy consumption coupons provided to each of the target group of users.

18. The system of claim 17 wherein the system certifies those of the target group of users who successfully employ the associated renewable energy consumption coupons to pay for the entire energy consumed by a purchased appliance or vehicle as green consumers (GC).

19. The system of claim 13 wherein the system determines which of the target group of users are unable to successfully meet all their energy needs employing the renewable energy coupons.

20. The system of claim 19 further comprising:
a utility billing server interface that provides access to data maintained by a utility company, wherein the utility company maintains and manages an energy grid;
the utility billing server interface providing access to a utility company billing server associated with the utility company; and
the system conducting renewable energy coupon settlement with the utility company billing server, via the a utility billing server interface, when the utility company billing server accepts the renewable energy coupons redeemed by the target group of users as partial or complete payments for energy consumed and communicates the accepted renewable energy coupons for verification to the system.
